(19) United States
(12) Patent Application Publication
(10) Pub. No.: US 2016/0092908 A1
(43) Pub. Date: Mar. 31, 2016

(54) METHOD AND SYSTEM FOR PROCESSING AUTOMATIC PRODUCT DISCOUNTS AT POINT OF SALE

(71) Applicant: MasterCard International Incorporated, Purchase, NY (US)

(72) Inventors: Jose-Luis CELORIO-MARTINEZ, New York, NY (US); Sheila Narayanan, Ardsley, NY (US)

(73) Assignee: MasterCard International Incorporated, Purchase, NY (US)

(21) Appl. No.: 14/498,042

(22) Filed: Sep. 26, 2014

(51) Int. Cl. G06Q 30/02

(52) U.S. Cl. CPC G06Q 30/0238

(57) ABSTRACT

A method for processing account and product linked offers includes: storing data related to a payment transaction including a transaction amount, product data associated with one or more products, and account data associated with a transaction account; transmitting an offer data request, wherein the offer request includes the stored product data and account data; receiving offer data in response to the transmitted offer data request, wherein the offer data includes a transaction modifier and is associated with the stored product data and account data; calculating a modified transaction amount based on the stored transaction amount and the transaction modifier included in the received offer data; and transmitting the calculated modified transaction amount and account data for use in processing a payment transaction.

### FIELD

The present disclosure relates to the processing of account and product linked offers, specifically the processing of discounts at a point of sale for specific products as linked to a transaction account being used in a payment transaction for the specific products.

### BACKGROUND

Product manufacturers often seek new and innovative ways to market their product to consumers and encourage consumers to purchase their product. One such method that many manufacturers use is the providing of coupons, discounts, or other offers related to the purchase of a product. For instance, a manufacturer may publish a coupon for 25% off the purchase of a specific product, in order to encourage consumers to purchase the product. Such an offer may be particularly advantageous in attracting a first-time consumer in the hopes of converting them to a recurring consumer for a perishable product.

However, in many instances, coupons and other types of offers may be inconvenient for consumers. Traditional paper coupons often require a consumer to first obtain the coupon, remember to carry the coupon when purchasing the item, and then remembering again to present the coupon at the point of sale. So many steps that require so many affirmative actions by a consumer can result in a low rate of redemption for a product, which may adversely affect sales and future purchases.

In some cases, manufacturers may distribute a vast number of coupons or offers, in the hope that wide distribution may compensate for a low rate of redemption for a coupon. However, in instances where the manufacturer may not anticipate a high rate of redemption, the manufacturer may be faced with honoring a large number of discounts, which may performed at significant expense to the manufacturer and outweigh the overall benefits.

Thus, there is a need for a technical solution for the providing of discounts to consumers that are consumer-specific, such that a product manufacturer may control redemption, and that are also easier and more efficient for a consumer to redeem, in an effort to increase rate of redemption.

### SUMMARY

The present disclosure provides a description of systems and methods for processing account and product linked offers.

A method for processing account and product linked offers includes: storing, in a memory, data related to a payment transaction including at least a transaction amount, product data associated with one or more products, and account data associated with a transaction account; transmitting, by a transmitting device, an offer data request, wherein the offer request includes at least the stored product data and account data; receiving, by a receiving device, offer data in response to the transmitted offer data request, wherein the offer data includes at least a transaction modifier and is associated with the stored product data and account data; calculating, by a processing device, a modified transaction amount based on at least the stored transaction amount and the transaction modifier included in the received offer data; and transmitting, by the transmitting device, at least the calculated modified transaction amount and account data for use in processing a payment transaction.

A system for processing account and product linked offers includes: a memory configured to store data related to a payment transaction including at least a transaction amount, product data associated with one or more products, and account data associated with a transaction account; a transmitting device configured to transmit an offer data request, wherein the offer request includes at least the stored product data and account data; a receiving device configured to receive offer data in response to the transmitted offer data request, wherein the offer data includes at least a transaction modifier and is associated with the stored product data and account data; and a processing device configured to calculate a modified transaction amount based on at least the stored transaction amount and the transaction modifier included in the received offer data, wherein the transmitting device is further configured to transmit at least the calculated modified transaction amount and account data for use in processing a payment transaction.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the processing of account and product linked offers in accordance with exemplary embodiments.

FIG. 2 is a block diagram illustrating the processing server of FIG. 1 for the processing of account and product linked offers in accordance with exemplary embodiments.

FIG. 3 is a flow diagram illustrating a process for processing account and product linked offers using the system of FIG. 1 in accordance with exemplary embodiments.

FIG. 4 is a flow diagram illustrating a process for the discounting of a payment transaction using a product and account linked offer in accordance with exemplary embodiments.

FIG. 5 is a flow chart illustrating an exemplary method for processing account and product linked offers in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

### System for Processing Account and Product Linked Offers

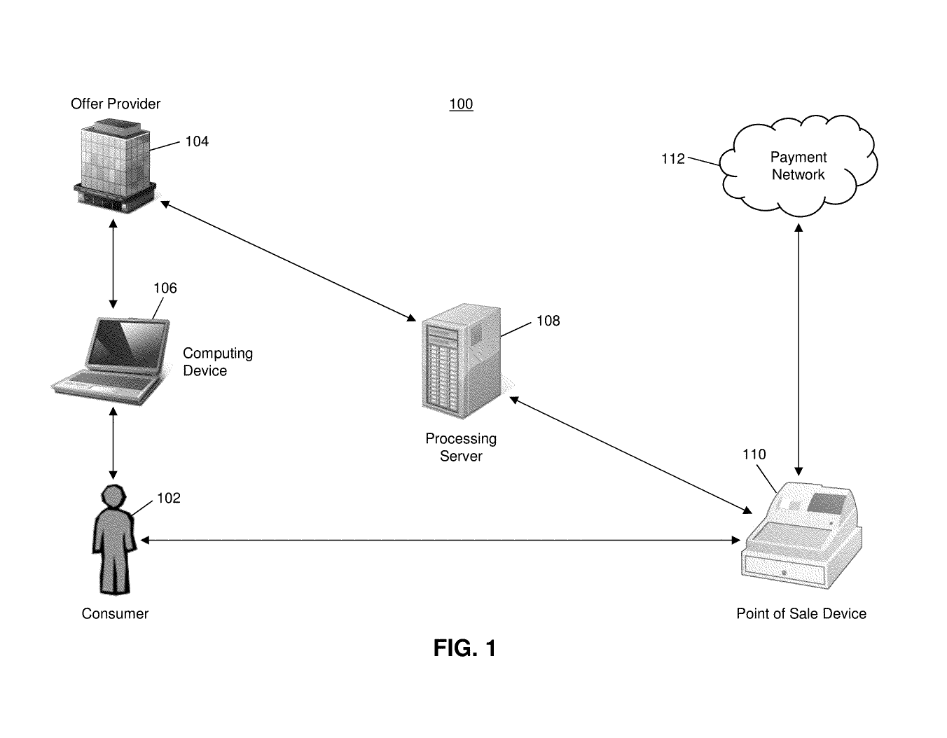

FIG. 1 illustrates a system 100 for processing offers linked to a product being purchased at a point of sale and an account being used to fund the payment transaction.

The system 100 may include a consumer 102. The consumer 102 may have a transaction account with a financial institution that the consumer 102 may be able to use to fund a payment transaction. The transaction account may be a payment card account, debit account, checking account, or any other suitable type of account as will be apparent to persons having skill in the relevant art. The consumer 102 may receive an offer for the purchase of a product from an offer provider 104. The offer provider 104 may be a product manufacturer, retailer, merchant, deal provider, advertiser, or other entity that may distribute product offers to consumers.

In some embodiments, the offer provider 104 may distribute a product offer to the consumer 102 via a computing device 106. For example, the consumer 102 may receive a product offer via a website, e-mail, short message service (SMS) message, an application program, or other suitable means using the computing device 106. The computing device 106 may be a desktop computer, laptop computer, notebook computer, laptop computer, smart phone, cellular phone, personal digital assistant, smart watch, smart television, etc. The consumer 102 may receive the product offer using the computing device 106 and may accept the offer from the offer provider 104. Methods for accepting an offer will be apparent to persons having skill in the relevant art.

As part of the acceptance of the offer, the consumer 102 may provide the offer provider 104 with account details identifying a transaction account associated with the consumer 102. In some embodiments, the offer provider 104 may already possess account identification information prior to distribution of the product offer to the consumer 102. For example, the offer provider 104 may be a merchant with whom the consumer 102 has transacted previously, may have received the account information from a third party (e.g., an advertiser), etc. The account identification information may include at least an account identifier. The account identifier may be any unique value suitable for identification of a specific transaction account, such as an account number, reference number, username, e-mail address, telephone number, etc.

In some embodiments, the offer provider 104 may pre-select or predetermine offers for the consumer 102, without explicit selection of offers by the consumer 102. For instance, the offer provider 104 may be configured to identify offers for the consumer 102 based on information previously provided by the consumer 102, previously accepted offers of the consumer 102, and/or other information that will be apparent to persons having skill in the relevant art.

Once offers have been identified by and/or for the consumer 102, the offer provider 104 may provide the account identification information and product offer information to a processing server 108. The processing server 108 may be a computing device configured to store data regarding product offers that have been accepted by consumers 102. The data may include offer details and at least identification information for a transaction account to which an offer is linked. For example, the processing server 108 may store offer data and a transaction account number for a transaction account to which an offer is associated, such as the transaction account of the consumer 102 that accepted the offer from the offer provider 104.

In order to redeem the accepted offer, the consumer 102 may visit a merchant, such as by visiting a physical location of a merchant, accessing a webpage associated with the merchant, using an application program associated with the merchant (e.g., using the computing device 106), or other suitable method. The consumer 102 may initiate a payment transaction for at least the product to which the accepted offer is associated at a point of sale device 110. The point of sale device 110, discussed in more detail below, may be configured to initiate and process payment transactions at a merchant using methods and systems that will be apparent to persons having skill in the relevant art.

As part of the initiation of the payment transaction, the consumer 102 may provide to the point of sale device 110 (e.g., or to an employee to input into the point of sale device 110) with payment details for a transaction account being used to fund the payment transaction. The payment details may include account identification information for the transaction account to which the accepted product offer is associated. The point of sale device 110 may transmit product data for the product being purchase, such as a product identifier (e.g., universal product code, serial number, stock-keeping unit, European article number, etc.), and the account identification information to the processing server 108.

The processing server 108 may then identify if an accepted offer corresponds to both the transaction account being used to fund the payment transaction and one of the products being purchase as indicated in the product data. The processing server 108 may then transmit a notification to the point of sale device 110 accordingly, indicating if there is a corresponding offer. In instances where an accepted offer has been identified, the processing server 108 may transmit corresponding offer data to the point of sale device 110, such as a transaction modifier based on the accepted offer. For instance, the transaction modifier may indicate a 10% discount, a flat discount (e.g., $5 off), or other type of modification as will be apparent to persons having skill in the relevant art. For example, in one embodiment, the transaction modifier may be based on the use of points by the consumer 102. In such an example, the consumer 102 may have a points account with the offer provider 104 or other suitable entity. The points may be used to affect the value (e.g., modification) of offers, availability of offers, redemption of offers, etc. For instance, a series of offers for a merchant may have a different modifier based on an amount of points used by the consumer 102 for the offer, such as 5% off, 10% off, 20% off, etc.

The point of sale device 110 may then discount the transaction accordingly based on the offer details. The point of sale device 110 may generate an authorization request for the payment transaction for the discounted amount, and may submit the authorization request to a payment network 112 for processing. In some instances, the point of sale device 110 may transmit transaction data for the payment transaction, including the modified transaction amount and payment details, to an acquiring financial institution, which may be configured to communicate with the payment network 112 on behalf of the point of sale device 110. The payment network 112 may process the payment transaction using methods and systems that will be apparent to persons having skill in the relevant art.

The payment network 112 may provide an authorization response to the point of sale device 110 (e.g., via the acquirer) indicating approval or denial of the payment transaction. The point of sale device 110 (e.g., and the merchant associated with the point of sale device 110) may finalize the payment transaction accordingly, such as by furnishing the consumer 102 with the purchased product(s) and a receipt for an approved transaction. If the transaction is approved, the point of sale device 110 may transmit a notification to the processing server 108. The processing server 108 may then update the stored data to indicate that the product offer has been redeemed, such as for removal of the product offer in instances where an offer may only be redeemed once. Methods and systems for processing redemption of an offer will be apparent to persons having skill in the relevant art.

By processing discounts for a payment transaction at a point of sale that are linked to a product and an account, the point of sale device 110 may be able to process discounts for a consumer 102 more efficiently than traditional methods and systems, as the discounts may be applied automatically without the consumer 102 being required to present any coupon or physical item, or even notify an employee of the merchant that a discount is available. In addition, by the discount being linked to a specific transaction account, the offer provider 104 may be able to ensure that only desired consumers 102 may receive the discount, which may control levels of redemption and may make better use of consumer targeting. As a result, the point of sale device 110 may be able to improve over traditional systems for discounting of products being purchased.

### Point of Sale Device

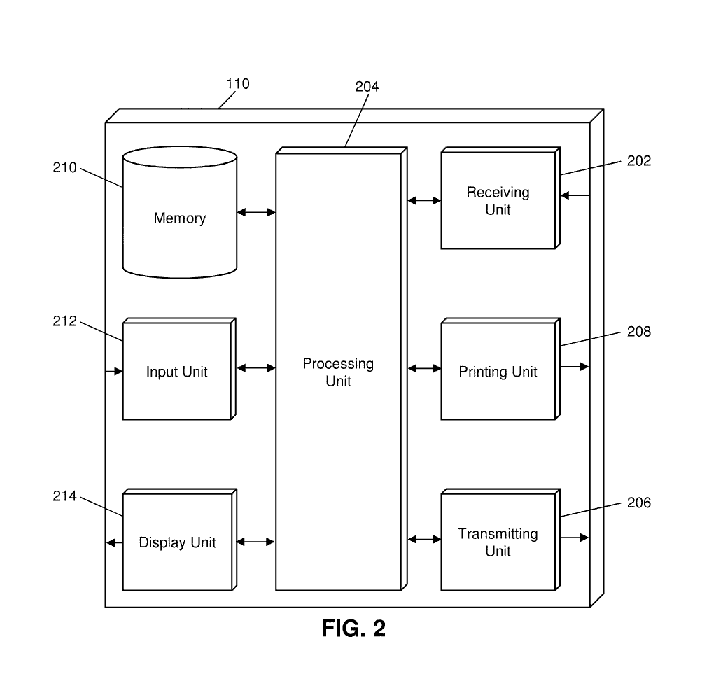

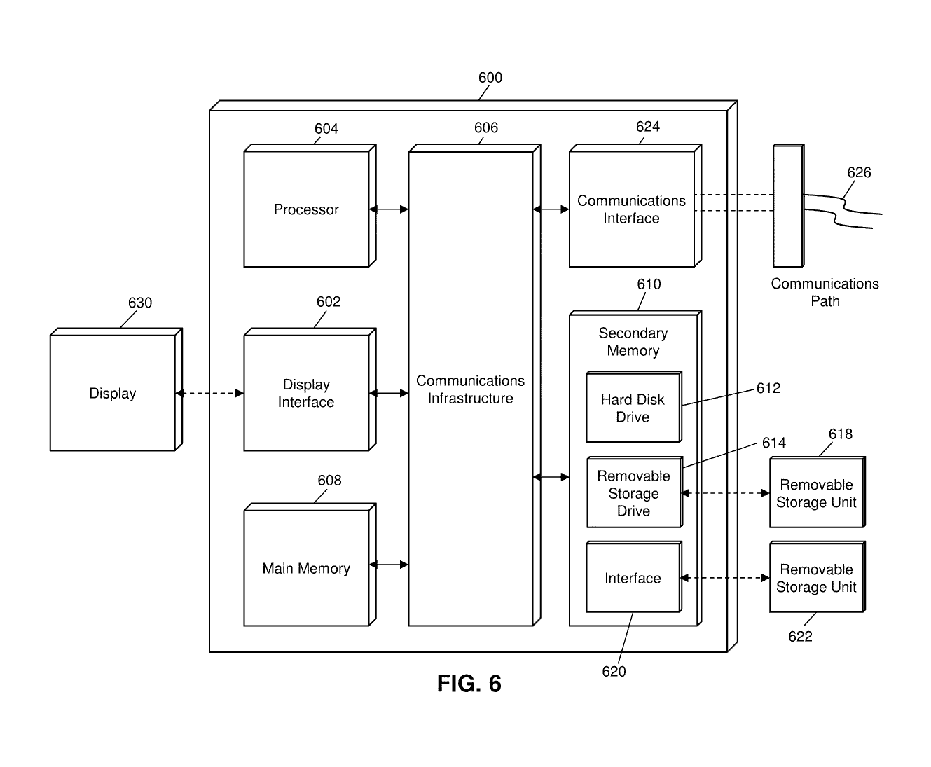

FIG. 2 illustrates an embodiment of the point of sale device 110 of the system 100. It will be apparent to persons having skill in the relevant art that the embodiment of the point of sale device 110 illustrated in FIG. 2 is provided as illustration only and may not be exhaustive to all possible configurations of the point of sale device 110 suitable for performing the functions as discussed herein. For example, the computer system 600 illustrated in FIG. 6 and discussed in more detail below may be a suitable configuration of the point of sale device 110.

The point of sale device 110 may include an input unit 212. The input unit 212 may be configured to receive data via one or more input devices, such as a keyboard, mouse, click wheel, scroll wheel, touch screen, microphone, camera, optical reader, magnetic stripe reader, near field communication terminal, etc. For instance, the input unit 212 may read product identification data encoded in a universal product code read by an optical reader connected to the point of sale device 110. The input unit 212 may be configured to receive product data, such as product identifiers, associated with one or more products being purchased, and payment details, such as read from a payment card or received from a computing device, such as the computing device 106.

The point of sale device 110 may also include a processing unit 204. The processing unit 204 may be configured to perform the functions of the point of sale device 110 as discussed herein. The processing unit 204 may be configured to store the received product data and payment details in a memory 210. The memory 210 may be configured to store data for the point of sale device 110 suitable for performing the functions disclosed herein.

The point of sale device 110 may further include a transmitting unit 206. The transmitting unit 206 may be configured to transmit data over one or more networks via one or more network protocols. The transmitting unit 206 may transmit product data and account data to the processing server 108. The product data may include at least a product identifier associated with each product being purchased. The account data may include at least account identification information associated with the transaction account being used to fund the payment transaction. The data may be transmitted to the processing server 108, which may identify an offer linked to the transaction account and one or more products being purchased.

The point of sale device 110 may also include a receiving unit 202. The receiving unit 202 may be configured to receive data over one or more networks via one or more network protocols. The receiving unit 202 may receive offer data from the processing server 108 associated with an offer for one or more of the products being purchased linked to the transaction account being used to fund the payment transaction. The offer data may include at least a transaction modifier associated with the offer, and may further include an offer name, description, image, terms of redemption, etc. In some embodiments, the transmitting unit 206 may also transmit a merchant identifier associated with a merchant involved in the payment transaction, and the received offer data may be corresponding to an offer that is also linked to the involved merchant.

The processing unit 204 may be configured to calculate a transaction amount for the payment transaction based on the product data stored in the memory 210, and discount the transaction amount accordingly based on the transaction modifier included in the received offer data. The processing unit 204 may then, in some embodiments, generate an authorization request for the payment transaction for the discounted transaction amount. The transmitting unit 206 may transmit the generated authorization request to the payment network 112 for processing. In other embodiments, the transmitting unit 206 may transmit the discounted transaction amount to an acquirer for use in generating and submitting an authorization request to the payment network 112.

The receiving unit 202 may be further configured to receive an authorization response from the payment network 112 (e.g., via an acquirer) indicating approval or denial of the payment transaction. The processing unit 204 may be configured to perform one or more actions accordingly based on the received authorization response. For example, if the authorization response indicates approval of the payment transaction, the processing unit 204 may cause the transmitting unit 206 to transmit a notification to the processing server 108 indicating successful redemption of the offer.

The point of sale device 110 may also include a printing unit 208. The printing unit 208 may be configured to interface with one or more printing devices for the printing of material associated with the payment transaction. For example, the printing unit 208 may be configured to cause a printing device to print a receipt for the payment transaction upon receipt of an authorization response from the payment network 112. The printing unit 208 may be further configured to reflect the corresponding transaction modifier on the printed receipt for the payment transaction. For instance, the receipt may include the transaction modifier (e.g., 10% off), which may be used by the consumer 102 for reference and may reinforce the value proposition of the solution to the consumer 102. Additional functions of the printing unit 208 will be apparent to persons having skill in the relevant art.

The point of sale device 110 may further include a display unit 214. The display unit 214 may be configured to cause one or more display devices in communication with (e.g., connected to) the point of sale device 110 to display data, such as to an employee or the consumer 102. The display devices may include, for instance, a cathode ray tube display, liquid crystal display, light-emitting diode display, capacitive touch display, thin film transistor display, etc. The display unit 214 may cause a display device to display, for instance, the product data for the product(s) being purchase, offer data received from the processing server 108, and other data that will be apparent to persons having skill in the relevant art.

It will be further apparent to persons having skill in the relevant art that the components of the point of sale device 110 illustrated in FIG. 2 and discussed herein may be further configured to perform additional functions of the point of sale device 110. For example, the components of the point of sale device 110 may be further configured to perform functions necessary for the reading of product data and payment details and initiation of payment transactions as will be apparent to persons having skill in the relevant art.

### Processing of Account and Product Linked Offers

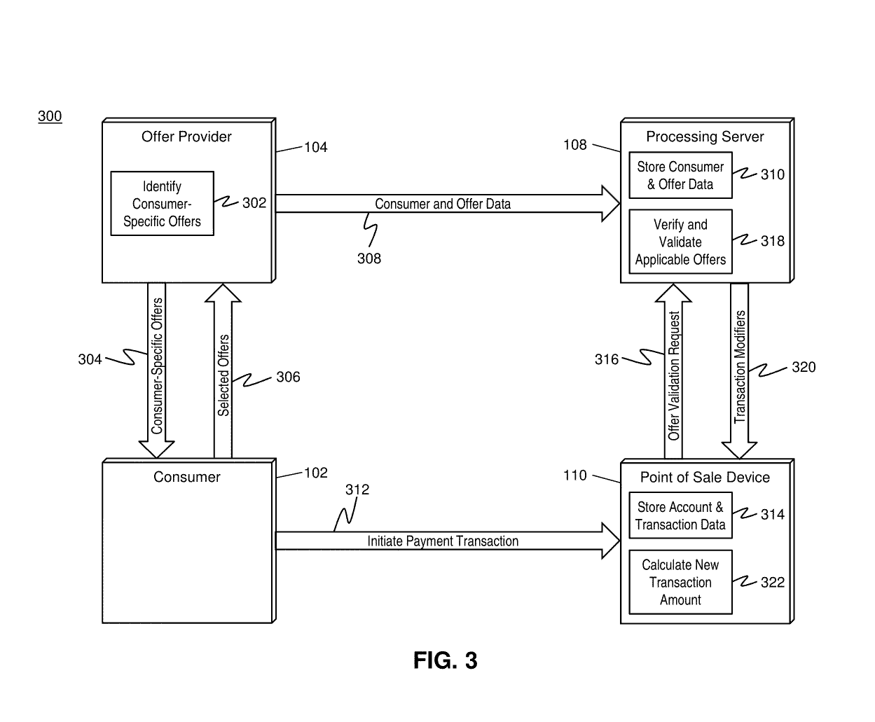

FIG. 3 illustrates a process 300 for the processing of account and product linked offers using the system 100 of FIG. 1.

In step 302, the offer provider 104 may identify one or more consumer-specific product offers that are specific to the consumer 102 using methods and systems that will be apparent to persons having skill in the relevant art. In step 304, the offer provider 104 may distribute the consumer-specific product offers to the consumer 102, such as via the computing device 106. The consumer 102 may review the offers, and, in step 306, may accept one or more of the product offers. The offer provider 104 may receive the selection by the consumer 102 of the accepted offers (e.g., via the computing device 106) and may receive and/or identify account identification information associated with a transaction account associated with the consumer 102 to be used in redemption of the selected offers. It will be apparent to persons having skill in the relevant art that, in some embodiments, steps 304 and 306 may be optional steps. In such embodiments, the offer provider 104 may pre-select or predetermined offers for the consumer 102.

In step 308, the offer provider 104 may provide the account identification information and offer data for the selected offers to the processing server 108. In step 310, the processing server 108 may store the account identification information associated with the consumer's 102 transaction account and the offer data in a database or other suitable method of storage. In step 312, the consumer 102 may initiate a payment transaction at the point of sale device 110.

In step 314, the point of sale device 110 may receive and store transaction data for the initiated payment transaction and account data associated with the transaction account of the consumer 102 in the memory 210. The transaction data may include product data, such as read by the input unit 212, identified by the processing unit 204, and/or received by the receiving unit 202 (e.g., from a merchant computing system, such as housing a product database for products offered). The transaction data may also include a transaction amount, which may be calculated by the processing unit 204 using the product data. The account data may include account identification information and other payment details, which may be read from a payment card presented by the consumer 102 or otherwise obtained from the consumer 102.

In step 316, the point of sale device 110 may transmit (e.g., via the transmitting unit 206) an offer validation request to the processing server 108. The offer validation request may be a request to identify and validate a product offer associated with the transaction account being used to fund the payment transaction and one or more of the products being purchased. The offer validation request may include at least the account data and product data stored in the memory 210.

In step 318, the processing server 108 may verify the existence of at least one product offer linked with a product being purchased and the transaction account used in the payment transaction and may validate the offer using methods and systems that will be apparent to persons having skill in the relevant art, such as by reviewing any limitations on redemption (e.g., quantity, expiration date, start date, etc.) In step 320, the processing server 108 may transmit offer data for each verified and validated offer to the point of sale device 110, which may include at least a transaction modifier corresponding to each offer. In step 322, the processing unit 204 of the point of sale device 110 may calculate a new, discounted transaction amount using the received transaction modifier(s). The point of sale device 110 may then proceed with the payment transaction for the discounted amount using methods and systems that will be apparent to persons having skill in the relevant art.

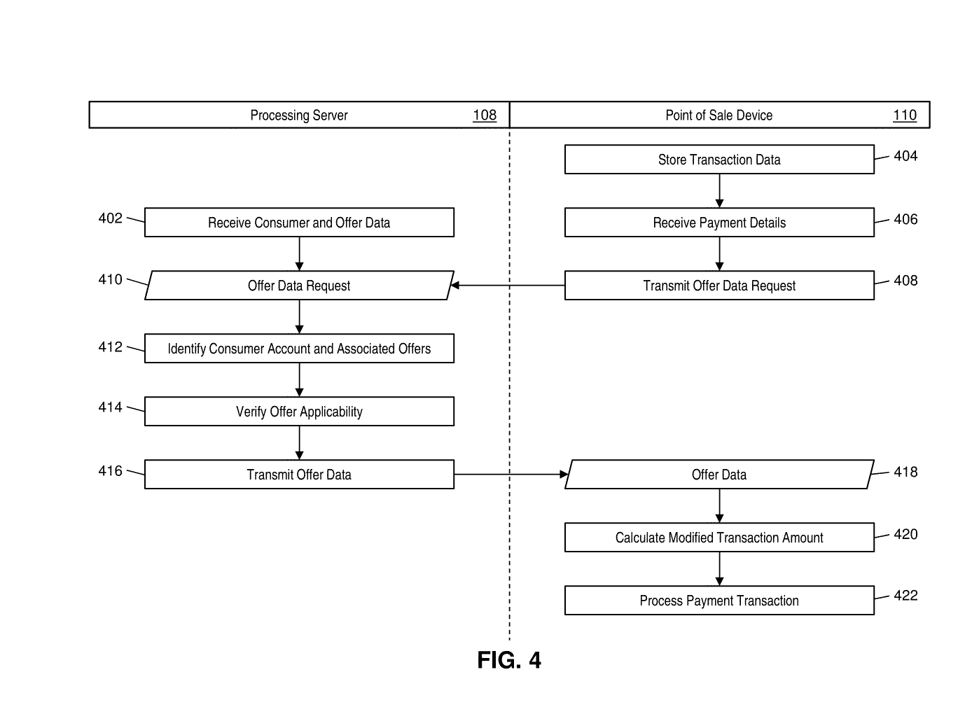

FIG. 4 illustrates a more detailed method for the processing of the account and product linked offers between the processing server 108 and the point of sale device 110.

In step 402, the processing server 108 may receive consumer and offer data from the offer provider 104 for one or more product offers accepted by the consumer 102. The consumer data may include at least account identification information associated with one or more transaction accounts associated with the consumer 102 that may be used in redemption of the accepted offers. In step 404, the point of sale device 110 may store transaction data for a payment transaction involving the consumer 102. The transaction data may include product data for one or more products being purchased, and may also include a transaction amount based on amounts for the products being purchased.

In step 406, the input unit 212 and/or receiving unit 202 of the point of sale device 110 may receive payment details for the payment transaction from the consumer 102. The payment details may include at least a transaction account number or other account identification information associated with a transaction account being used by the consumer 102 to fund the payment transaction. In step 408, the transmitting unit 206 of the point of sale device 110 may transmit an offer data request to the processing server 108.

In step 410, the processing server 108 may receive the offer data request. The offer data request may include at least the account identification information and the product data. In step 412, the processing server 108 may identify accepted offers that are associated with the consumer 102 involved in the payment transaction by identifying stored offer data that is associated with the account identification information included in the offer data request. In step 414, the processing server 108 may identify if any of the offers accepted by the associated consumer 102 are applicable to the payment transaction based on the stored offer data and the product data included in the received offer data request. An offer may be applicable if the product data includes a product associated with the offer, and if any additional terms or restrictions for the offer are met.

In step 416, the processing server 108 may transmit offer data for one or more identified, applicable offers to the point of sale device 110. In step 418, the receiving unit 202 of the point of sale device 110 may receive the offer data. The offer data may include at least a transaction modifier for each of the applicable offers. In step 420, the processing unit 204 may calculate a modified transaction amount for the payment transaction based on the initial transaction amount and the transaction modifier for each of the applicable offers included in the received offer data. Once the discounted transaction amount has been calculated, then, in step 422, the payment transaction may be processed by the point of sale device 110 using methods and systems that will be apparent to persons having skill in the relevant art.

In some embodiments, the method may further include the transmitting unit 206 of the point of sale device 110 transmitting a notification to the processing server 108 indicating successful redemption of each applicable offer. In such an embodiment, the processing server 108 may update the stored consumer data accordingly, such as by removing a redeemed offer or updating a redemption quantity of a redeemed offer.

### Exemplary Method for Processing Account and Product Linked Offers

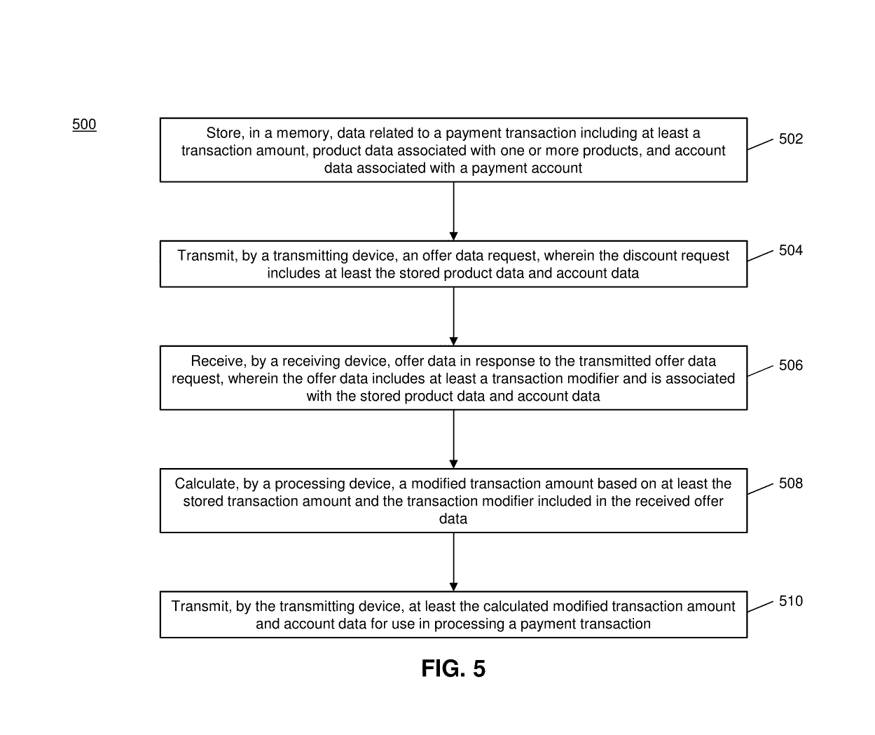

FIG. 5 illustrates a method 500 for the processing of account and product linked offers at a point of sale prior to processing of a payment transaction.

In step 502, data related to a payment transaction may be stored in a memory (e.g., the memory 210) including at least a transaction amount, product data associated with one or more products, and account data associated with a payment account. In step 504, an offer data request may be transmitted by a transmitting device (e.g., the transmitting unit 206), wherein the discount request includes at least the stored product data and account data.

In step 506, offer data may be received by a receiving device (e.g., the receiving unit 202) in response to the transmitted offer data request, wherein the offer data includes at least a transaction modifier and is associated with the stored product data and account data. In one embodiment, the transmitted offer data request may further include merchant data, and the received offer data may be further associated with the merchant data.

In step 508, a modified transaction amount may be calculated by a processing device (e.g., the processing unit 204) based on at least the stored transaction amount and the transaction modifier included in the received offer data. In some embodiments, the stored product data may be associated with a plurality of products and may include a product amount, the received offer data may include a transaction modifier and offer data associated with each of two or more products of the plurality of products, and calculating the modified transaction amount may be further based on the product amount and transaction modifier associated with each of the two or more products.

In step 510, at least the calculated modified transaction amount and account data may be transmitted, by the transmitting device 206, for use in processing a payment transaction. In one embodiment, the offer data request may be transmitted unique a first communication channel and the calculated modified transaction amount and account data may be transmitted unique a second communication channel. In some embodiments, the calculated modified transaction amount and account data may be transmitted as part of an authorization request submitted to a payment network (e.g., the payment network 112)

In one embodiment, the method 500 may further include displaying the received offer data to a consumer (e.g., the consumer 102) associated with the stored account data. In a further embodiment, the received offer data may be displayed on at least one of: a display device, a printed coupon, and a receipt.

### Computer System Architecture

FIG. 6 illustrates a computer system 600 in which embodiments of the present disclosure, or portions thereof, may be implemented as computer-readable code. For example, the point of sale device 110 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3-5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for processing account and product linked offers. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing account and product linked offers, comprising:
storing, in a memory, data related to a payment transaction including at least a transaction amount, product data associated with one or more products, and account data associated with a transaction account;
transmitting, by a transmitting device, an offer data request, wherein the offer request includes at least the stored product data and account data;
receiving, by a receiving device, offer data in response to the transmitted offer data request, wherein the offer data includes at least a transaction modifier and is associated with the stored product data and account data;
calculating, by a processing device, a modified transaction amount based on at least the stored transaction amount and the transaction modifier included in the received offer data; and
transmitting, by the transmitting device, at least the calculated modified transaction amount and account data for use in processing a payment transaction.

2. The method of claim 1, wherein the calculated modified transaction amount and account data are transmitted as part of an authorization request submitted to a payment network.

3. The method of claim 1, wherein the transmitted offer data request further includes merchant data, and the offer data is further associated with the merchant data.

4. The method of claim 1, further comprising:
displaying the received offer data to a consumer associated with the stored account data.

5. The method of claim 4, wherein the received offer data is displayed on at least one of: a display device, a printed coupon and a receipt.

6. The method of claim 1, wherein the offer data request is transmitted using a first communication channel and the calculated modified transaction amount and account data are transmitted using a second communication channel.

7. The method of claim 1, wherein
the stored product data is associated with a plurality of products and includes a product amount,
the received offer data includes a transaction modifier and offer data associated with each of two or more products of the plurality of products, and
calculating the modified transaction amount is further based on the product amount and transaction modifier associated with each of the two or more products.

8. A system for processing account and product linked offers, comprising:
a memory configured to store data related to a payment transaction including at least a transaction amount, product data associated with one or more products, and account data associated with a transaction account;
a transmitting device configured to transmit an offer data request, wherein the offer request includes at least the stored product data and account data;
a receiving device configured to receive offer data in response to the transmitted offer data request, wherein the offer data includes at least a transaction modifier and is associated with the stored product data and account data; and
a processing device configured to calculate a modified transaction amount based on at least the stored transaction amount and the transaction modifier included in the received offer data, wherein
the transmitting device is further configured to transmit at least the calculated modified transaction amount and account data for use in processing a payment transaction.

9. The system of claim 8, wherein the calculated modified transaction amount and account data are transmitted as part of an authorization request submitted to a payment network.

10. The system of claim 8, wherein the transmitted offer data request further includes merchant data, and the offer data is further associated with the merchant data.

11. The system of claim 8, further comprising:
a display device configured to display the received offer data to a consumer associated with the stored account data.

12. The system of claim 8, further comprising:
a printing device configured to print the received offer data for a consumer associated with the stored account data.

13. The system of claim 8, wherein the offer data request is transmitted using a first communication channel and the calculated modified transaction amount and account data are transmitted using a second communication channel.

14. The system of claim 8, wherein
the stored product data is associated with a plurality of products and includes a product amount,
the received offer data includes a transaction modifier and offer data associated with each of two or more products of the plurality of products, and
calculating the modified transaction amount is further based on the product amount and transaction modifier associated with each of the two or more products.
